(19) United States
(12) Patent Application Publication
(10) Pub. No.: US 2007/0124750 A1
(43) Pub. Date: May 31, 2007

(54) Method and device for digital broadcasting

(75) Inventors: Rajendra Singh Sisodia, Bhopal (M.P.) (IN); Nittin Koppalkar, Bangalore (IN); Animesh Bhowmick, Bangalore (IN)

Correspondence Address: PHILIPS INTELLECTUAL PROPERTY & STANDARDS, P.O. BOX 3001, BRIARCLIFF MANOR, NY, 10510, US

(73) Assignee: Koninklijke Philips Electronics N.V., Eindhoven (NL)

(21) Appl. No.: 10/572,617

(22) PCT Filed: Sep. 1, 2004
(86) PCT No.: PCT/IB04/51650

§ 371 Date: Mar. 17, 2006

(30) Foreign Application Priority Data
Sep. 22, 2003 (EP) 03103489.5

(51) Int. Cl. H04N 7/16

(52) U.S. Cl. 725/1

(57) ABSTRACT

This invention relates to a broadcasting system/method where a broadcasting signal is encoded on the basis of one or more region codes. During decoding a decryption key and/or a pay-mode key is used where the keys is dependent on a region code representing a physical location of a receiver. In this way, a simple, reliable and efficient way of enabling region dependent broadcasting is obtained. Further, it is possible to have different pay modes dependent on a physical location or region. Additionally, the pay modes may be changed dynamically since only the associations between the region codes and the pay-modes need to be updated.

The present invention relates to digital video broadcasting (DVB). More specifically, the invention relates to a method, and a corresponding device, of transmitting/broadcasting a broadcast signal and to a method, and corresponding device, of receiving a broadcast signal. Further, the invention relates to a system comprising a broadcast device and a receiver device and to a computer readable medium having stored thereon instructions for causing one or more processing units to execute the method according to the invention.

In digital video broadcasting (DVB) pay-per-view television is a more and more used way of charging users for their viewing of a broadcast, e.g. a television show, a movie, etc., whereby a user e.g. selects a movie among a number of available movies and commits to pay for it after which the broadcast of the selected movie to the user is initiated. At the user's location a so-called set-top box is normally necessary for handling the reception of the digital signal comprising the movie and for performing security, payment and various other functions.

It is today typically only possible to have a given standard price associated with a given broadcast, i.e. it is not possible in a simple way to treat different users differently and e.g. charge a different price to different kinds of users, i.e. have a price differentiation between users.

Further, it is typically not possible in a simple way using existing DVB or pay-per-view systems to allow for certain users to have free access to a given broadcast while other users have to pay for it without having to treat the two groups of users differently and transmitting two different broadcasts. Further, it would be possible for the user that should pay for a given broadcast to see the free broadcast as long as they are able to receive it.

Additionally, it is not possible in a simple way to enable a dynamic change of a given price for a given broadcast initiated at the broadcaster's end.

Patent specification U.S. Pat. No. 5,036,537 discloses a system and a method for sending a blackout signal to broadcast receivers on a regional level. This is done by letting each receiver comprising a memory having stored a designation code representing its geographical and having stored a blackout tier. The designation codes and the blackout tier indications are distributed and stored in the receivers prior to the broadcast of the programming. During program transmission, programs are accompanied by a program tier. When a receiver has a stored blackout tier indication corresponding to the transmitted program tier indication accompanying a program it is unable to display that program.

It is an object of the invention to provide a method (and corresponding device) of transmitting a broadcast signal and to provide a method (and corresponding device) of receiving a broadcast signal that solves the abovementioned problems of prior art. Another object of the present invention is to enable region-dependent broadcasting, i.e. in the sense that viewers from different regions may have different rights for a given signal even though it is the same signal that is transmitted to all of them. A further object is to enable this in a simple and efficient way. Yet a further object is to incorporate different pay models into the broadcasting of a digital signal.

This is achieved by a method (and corresponding device) of receiving a broadcast signal, the method comprising the steps of
receiving an encoded broadcast signal in a receiver from a broadcast device, where the encoded broadcast signal have been encoded on the basis of at least one region code each representing a region,
obtaining a region code of a region that the receiver is located in,
obtaining a decoding key in the receiver, and
decoding the broadcast signal using the obtained decoding key and on the basis of the obtained region code.

and by a method (and corresponding device) of transmitting a broadcasting signal, the method comprising the steps of:
obtaining, in a broadcast device, a signal to be transmitted to a number of receivers,
encoding the signal with a number of orthogonal encoding keys and on the basis of one or more a region codes representing a region, thereby generating an encoded broadcast signal, and
transmitting the encoded broadcast signal to a number of receivers.

In this way, a simple, reliable and efficient way of enabling region dependent broadcasting is obtained.

Further, the need of costly set-top boxes as a mininum criterion for viewing pay channels is avoided, since only a receiver being able to obtain a region code and derive a pay-mode is needed.

Additionally, this also allows for a very scalable system-architecture with respect to how many different pay-modes or price differentiations a system can handle or incorporate, since it depends only on the region code's granularity.

Additionally, different regions, which are controlled by different governing bodies and have different sets of rules, may also be handled in a relatively simple way, since the various rules may be encoded and decoded with region codes.

In a preferred embodiment, the method (and corresponding devices) further comprises the step of obtaining a pay-mode and in that the step of decoding the broadcast signal further comprises using a pay-mode key being dependent on the obtained pay-mode.

Hereby, it is possible to have different pay modes dependent on a geographical/physical location or region. Additionally, the pay modes may be changed dynamically since only the associations between the region codes and the pay-modes need to be updated.

Preferably,
the decryption key is derived on the basis of the obtained region code and the pay-mode key is independent of the obtained region code, or
the pay-mode key is derived on the basis of the obtained region code and the decryption key is independent of the obtained region code, or
the decryption-key and the pay-mode key are derived on the basis of the obtained region code.

In a preferred embodiment, the region code (RC1, RC2, . . . ) of a region that the receiver (200) is located is determined by:
obtaining Global Positioning System (GPS) data from location determination means and using the obtained GPS data to derive the region code.

In this way, the determination of the physical/geographical position/location of a given receiver in a secure way is obtained, so no or little tampering, fraud, etc. is possible, thereby being able to securely obtain or determine the region code of the given receiver. Additionally, a change of the physical location of the receiver (e.g. if the user moves) does impose a restriction or difficulty since the new physical position/location will simply be detected after the change.

Other advantageous embodiments of the methods and devices according to the present invention are defined in the sub-claims and explained in the following.

The embodiments of the devices according to the present invention correspond to the embodiments of the methods according to the present invention and have the same advantages for the same reasons.

The invention also relates to a system comprising a broadcast device and a receiver device according to the present invention.

Further, the invention also relates to a computer readable medium having stored thereon instructions for causing one or more processing units to execute the method according to the present invention.

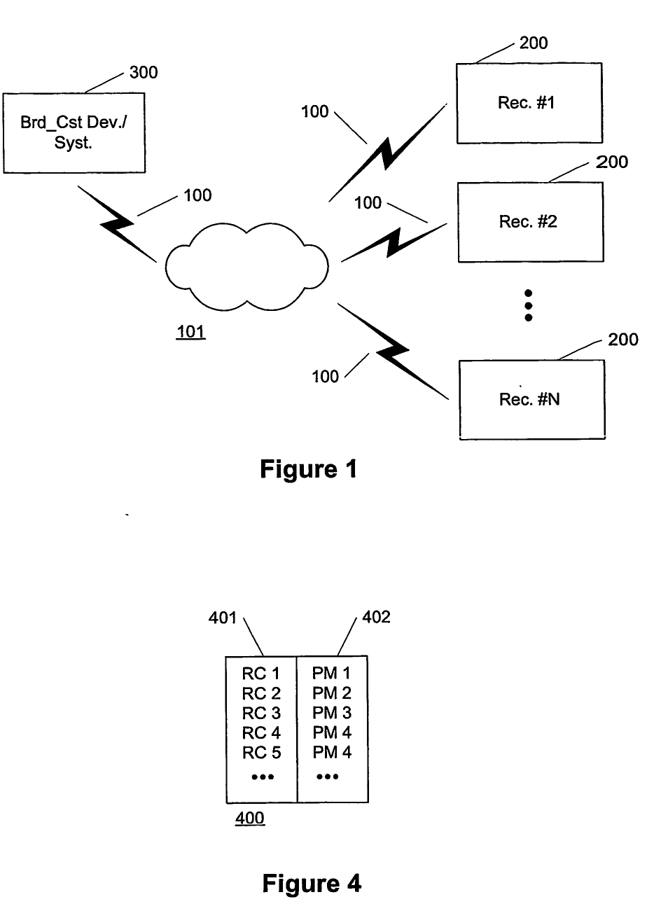

FIG. 1 illustrates a schematic overview of a system according to the present invention;

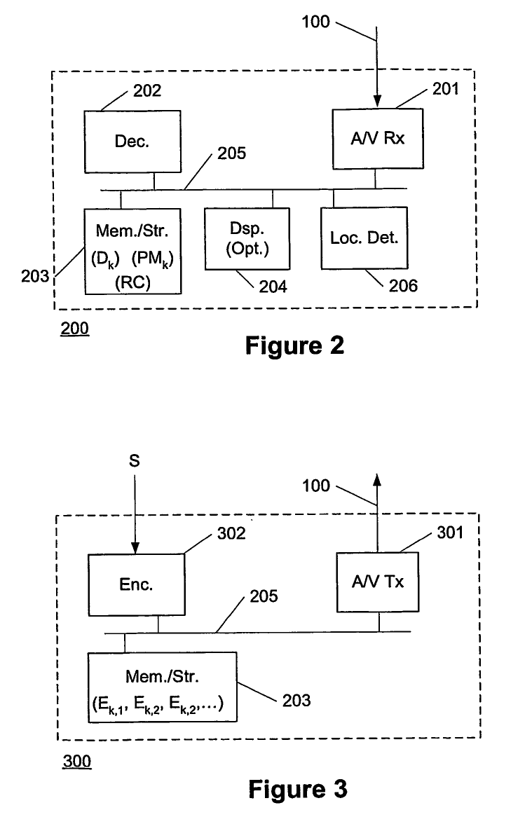

FIG. 2 illustrates a schematic block diagram of an embodiment of a receiver according to the present invention;

FIG. 3 illustrates a schematic block diagram of an embodiment of a broadcasting device/system according to the present invention;

FIG. 4 illustrates a simple table comprising values of region codes and their associated pay-modes.

FIG. 1 illustrates a schematic overview of a system according to the present invention. Shown are a broadcasting device or system (300) (forth denoted only broadcasting device) and a number of receivers (200). The broadcasting device (300) transmits a broadcasting signal (100) via a suitable distribution medium or network (101), e.g. cable, optical fibre, direct terrestrial connection, satellite connection, the Internet or another type of network and/or medium to at least one receiver (200). Preferably, each receiver (200) is a TV, display or monitor (forth denoted TV), a set-top box connected to a TV or a simpler receiver connected to or embedded in a TV.

A receiver (200) and a broadcasting device (300) are explained in greater detail in the following and in connection with FIG. 2 and FIG. 3, respectively.

The receivers (200) may be physically located in different regions, countries, cities, etc. Each receiver (200) is assigned a given region code depending on the physical/geographical location of the receiver (200).

A video stream/signal (S) (not shown) to be viewed at one or more receivers (200) is encoded/encrypted (forth denoted encoded) with a set of preferably orthogonal keys (E_{k,1}, E_{k,2}, E_{k,3}, . . . ) at the broadcast device (300) thereby generating an encoded broadcast signal (100). Alternatively, the broadcast device (300) receives the encoded broadcast signal (100) and simply handles the transmission. The set of keys is orthogonal in the sense that each key (or it's complementary) of the set on its own can be used to successfully decode/decrypt (forth denoted decrypt) the encoded signal and thereby obtaining the original signal (S). Preferably, a two-way (symmetric) encryption scheme is used, i.e. the same key is used to encode and to decode a given signal.

According to the present invention, the set of keys is preferably dependent on or a function of the region codes. Preferably, a given key is dependent on a given cryptographic key (in order to obtain secure encoding) and a given region code. One example is e.g. to let a key be equal to a combination or function of a DES (Data Encryption Standard) key or another type of cryptographic key and a region code, i.e. key 1=DES key+region code 1 or more generally key 1=F(DES key; region code 1).

By letting the key used also to decode a broadcast signal (100) being a function of the region code, a very simple and efficient way of ensuring that only receivers (200) being associated with a given specific region code (i.e. being located in that particular region) will be able to decode the signal and thereby allowing it to be viewed is obtained.

The encoded broadcast signal (100) is then transmitted to a number of receivers (200). After receiving the signal (100), a receiver (200) obtains it's region code (as explained elsewhere) and uses that to decode the signal (100) so that it may be viewed.

According to a further aspect of the present invention, a given pay mode is associated with a given region code, i.e. different pay modes exists for different region codes. In this way, a very simple way of obtaining price differentiation is obtained. Some areas would then have to pay e.g. more than other areas (having another region code). For some or a single region code the payment could e.g. be none, i.e. one or more region codes are related with a ‘Free-View’ pay-mode.

Preferably, a pay-mode associated with a given region code depends upon an (e.g. expected) interest of the users located in that region, whereby a user in a region that is expected to be more interested in the broadcast pays more than a user in a less interested region. For example, if a broadcast relates to a specific soccer match then users in a city or a country pays more if it is a local or national soccer team participating in the specific soccer match.

Further, the pay-mode associated with a given region code may e.g. depend upon the (e.g. expected, average, etc.) income of users within that given region, whereby users with more money pay more than users with less money, i.e. depending upon the region within a city, county, state, country, etc. the user pays more or less.

The use of pay-modes being dependent on region codes enables a very scalable payment scheme, since it depends solely on the region code area's granularity, i.e. several regions could be defined within a single city, county, state, country, etc.

In this way, it is possible to charge different amounts for the same broadcast content to users/receivers in different regions simply by associating each region code with a given pay-mode. This may be desirable and in general also allows for letting a broadcast to be viewable in different regions without affecting the revenues of a pay channel broadcaster. For example, in cities where people are willing to pay for viewing channels, the region code is related with the required pay-mode, thereby charging people (e.g. differently) for viewing the content, while letting people in remote (rural) areas, where the necessary decoders typically are not available or not financially viable, view the same channels for free by relating their region code with a Free-View pay-mode. Additionally, this is achieved without a need for complicated procedures/systems (during transmission and/or reception) and without a need for handling different signals to different users.

In a preferred embodiment, the user is informed about the pay-mode and/or the amount to be paid for a given selected broadcast and must accept it before the broadcast can be received or displayed.

This system is also dynamic, in the sense that a broadcaster is able to quite easily dynamically change a pay-mode for a given region simply by associating another pay-mode with the given region. This is very useful for example when any sport pay channel is broadcasting a match between two cities, the region codes of those two cities are aligned with a different pay mode in such a way that interested regions (i.e. the two cities) pay more while irrelevant or less interested regions are required to pay less or even nothing. After the match is over the region codes are aligned with other pay-modes or re-aligned to their original pay-mode, so that continued viewing of the sport pay channel now costs the normal amount.

Since the pay-mode is related to the region of the user or more specifically to a region code representing this, it is important to know or be able to determine the physical position/location of a given receiver (200) in a secure way, so no or little tampering, fraud, etc. is possible, thereby being able to securely obtain or determine the region code of the given receiver (200). One way of enabling this, is to let the receiver (200) comprise a GPS (Global Positioning System) circuit or let the receiver (200) be connected to another device having GPS capabilities. Alternatively, the receiver (200) comprises or is connected to another type of location/position determination means. As an example of such a device is e.g. a GPS enabled mobile device. Further, a change of the physical location of the receiver (e.g. if the user moves) does impose a restriction or difficulty since the new physical position/location will simply be detected after the change. As another alternative, the region code may be hardwired by the receiver vendor or cable operator.

On the basis of GPS data/information or other location information a relevant region code is derived.

As an alternative, if it is known about the “type” of channels or “name” of the channels, which are known to have designated as regional channel, it is still possible to have a price differentiation mechanism implemented. For example, consider an Amsterdam News channel, which is meant to have a regional effect and hence a corresponding regional code can be extracted (implicitly; considering Amsterdam as one region and rest as others). Hence a variable pay mode can be associated with this channel without encoding/encrypting the signal with a region code (as the region code can be implicitly deduced). The only decoding/decryption key needed is the pay mode key. For e.g. person within Amsterdam city has one pay model while whole Holland has another pay model while rest of EU countries have even another.

It is also important to use a secure way of encoding or encrypting (forth only denoted encoding) the broadcast signals. Preferably, the encoding of signals to be broadcasted should be done in such a way that it would be decoded only when a proper region code and a proper pay-mode are matched.

For example, an encoding scheme could be used where PMₖ (Dₖ(Eₖ (S)))=(S), where S is the broadcast signal in its non-encoded/non-encrypted form, Eₖ is the encoding key used to encode/encrypt the broadcast signal (S) according to the present invention in the broadcast device/system (300), Dₖ is a decoding/de-encryption key used to decode the broadcast signal (100), and where PMₖ is a (de-coding) pay-mode key. In this way, the un-encoded (and thereby viewable) signal (i.e. S) is obtained after applying the decryption (Dₖ) and the pay-mode key (PMₖ) on the encoded signal (Eₖ (S)) in a receiver.

Preferably at least one of the keys (Dₖ and PMₖ) is dependent on the region code i.e. giving the following three possibilities,
1) The decryption key (Dₖ) is derived/dependent from/on a given region code while the pay-mode key (PMₖ) is independent of region code,
2) The pay-mode key (PMₖ) is derived/dependent from/on a given region code while the decryption key (Dₖ) is independent of it, and
3) Both the decryption-key (Dₖ) and the pay-mode key (PMₖ) are dependent/derived on/from a given region code.

Some examples of well known symmetric encryption schemes is e.g. DES, Triple-DES (3DES), IDEA, CAST5, BLOWFISH, TWOFISH IDEA, RC2, RC4, Blowfish and Diamond.

For some encryption schemes, the order of applying the decryption keys (PMₖ and Dₖ) may not be important, i.e. PMₖ (Dₖ (signal))=Dₖ (PMₖ (signal)).

The pay mode, according to the above, may e.g. be implemented as an optional second layer of encryption in which different pay-modes each has a corresponding encryption layer. Note that, if a broadcaster wants a channel in a particular area as a free subscription channel, the second encryption layer is not required and it is sufficient that Dₖ(Eₖ (S))=(S) (or PMₖ=1 for a region code associated with free view). If a payment should be paid (e.g. for other areas), then a second layer of encryption should depend on different types of pay-modes.

FIG. 2 illustrates a schematic block diagram of an embodiment of a receiver according to the present invention. Shown are a decoder (202), an audio/video receiver circuit (201), a memory and/or storage (203), location determination means/a location determinator (206) and a display unit (204) connected via a communications bus (205) or a similar structure enabling the units to exchange information and data.

The receiver circuit (201) receives an encoded broadcast signal (100) transmitted from a broadcasting device (not shown) which is supplied to the decoder (202) together with data representing the given physical location of the receiver (200) from the location determination means (206). In the decoder (202) a region code (RC) for the receiver (200) is obtained on the basis of the data from the location determination means (206) and the encoded signal (100) is decoded as described earlier, e.g. using the region code as a part of the decryption key (Dₖ) e.g. stored in the memory/storage (203). The decoder (202) may comprise one or more generalised and/or specialised processing units.

Additionally, the applicable pay-mode (PM) (and pay-mode key PMₖ) is obtained. In one embodiment, the pay-mode PM is determined on the basis of the obtained region code (RC), e.g. by having a table like the one shown in FIG. 4 stored in the memory/storage (203). The given pay-mode key (PMₖ) is then derived from the obtained pay-mode (PM). In an alternative embodiment, the pay-mode may be encoded directly into the broadcast signal (100) and needs to be extracted by the receiver (200).

In a preferred embodiment, the broadcast signal (100) has been encoded with a second layer of encryption that only the appropriate pay-mode can de-crypt. This could e.g. be done by obtaining a decryption key being dependent on the pay-mode as is explained for the region code.

In this way, it is ensured that the broadcast signal is only going to be viewable if the receiver (200) has a right region code and a right pay-mode.

In a preferred embodiment, the user is informed about the relevant pay-mode and/or the amount to be paid for a given selected broadcast and must accept it before the broadcast can be received or displayed.

After successful decoding (and thereby verification of region-code and pay-mode) the un-coded signal is transmitted to the display unit (204) (that may be internal or external) for presentation.

In an alternative embodiment, the location determination means (206) is external but in communications connection with the receiver (200).

FIG. 3 illustrates a schematic block diagram of an embodiment of a broadcasting device according to the present invention. Shown is a broadcasting device (300) comprising an encoder (302), an audio/video transmitter circuit (301) and a memory and/or storage (203) connected via a communications bus (205) or a similar structure enabling the units to exchange information and data.

The encoder (302) receives a signal (S) to be broadcasted and encodes it like described earlier, i.e. with a set of orthogonal keys (E_{k,1}, E_{k,2}, E_{k,3}, . . . ) stored in the memory/storage (203), where each key (Eₖ) preferably is dependent on a given region code (RC). In one embodiment, the encoder (302) further applies a second layer of encryption in order to encode a pay mode directly into the broadcast signal. After the signal (S) has been encoded it is supplied to the transmitter (301), which broadcasts the encoded signal (100) so that it may be received by a number of receivers. The encoder (302) may comprise one or more generalised and/or specialised processing units.

Alternatively, the broadcasting device (300) may receive the broadcast signal (100) in its encoded form and simply handle the transmission.

FIG. 4 illustrates a simple table comprising values of region codes and their associated pay-modes. Shown is a table that illustrates the relation of a number region codes (RC1, RC2, . . . ) and a number of pay-modes (PM1, PM2, . . . ). One pay-mode (PM) is associated with a given region code. As shown, a given pay-mode (PM4 in the shown example) may be associated with more than a single region code (RC4 and RC5 in the shown example) simply signifying that the same amount is to be paid in both region RC4 and region RC5.

One of the pay-modes may e.g. be designated to represent a free-view mode.

Alternatively, the table could comprise region codes (RC1, RC2, . . . ) and a number of pay-mode keys.

In the claims, any reference signs placed between parentheses shall not be constructed as limiting the claim. The word “comprising” does not exclude the presence of elements or steps other than those listed in a claim. The word “a” or “an” preceding an element does not exclude the presence of a plurality of such elements.

The invention can be implemented by means of hardware comprising several distinct elements, and by means of a suitably programmed computer. In the device claim enumerating several means, several of these means can be embodied by one and the same item of hardware. The mere fact that certain measures are recited in mutually different dependent claims does not indicate that a combination of these measures cannot be used to advantage.

1. A method of receiving a broadcast signal, the method comprising the steps of
receiving an encoded broadcast signal (100) in a receiver (200) from a broadcast device (300), where the encoded broadcast signal (100) have been encoded on the basis of at least one region code (RC1, RC2, . . . ) each representing a region,
obtaining a region code (RC1, RC2, . . . ) of a region that the receiver (200) is located in,
obtaining a decoding key (Dₖ) in the receiver (200), and
decoding the broadcast signal (100) using the obtained decoding key (Dₖ) and on the basis of the obtained region code (RC1, RC2, . . . ).

2. A method according to claim 1, characterized in that the method further comprises the step of obtaining a pay-mode (PM1, PM2, . . . ) and in that the step of decoding the broadcast signal (100) further comprises using a pay-mode key (PMₖ) being dependent on the obtained pay-mode (PM1, PM2, . . . ).

3. A method according to claim 2, characterized in that
the decryption key (Dₖ) is derived on the basis of the obtained region code (RC1, RC2, . . . ) and the pay-mode key (PMₖ) is independent of the obtained region code (RC1, RC2, . . . ), or
the pay-mode key (PMₖ) is derived on the basis of the obtained region code (RC1, RC2, . . . ) and the decryption key (Dₖ) is independent of the obtained region code (RC1, RC2, . . . ), or
the decryption-key (Dₖ) and the pay-mode key (PMₖ) are derived on the basis of the obtained region code (RC1, RC2, . . . ).

4. A method according to claim 2, characterized in that the pay-mode (PM) is derived on the basis of the obtained region code (RC1, RC2, . . . ).

5. A method according to claim 1, characterized in that the step of obtaining a region code (RC1, RC2, . . . ) of a region that the receiver (200) is located in comprises:
obtaining Global Positioning System (GPS) data from location determination means (206) and using the obtained GPS data to derive the region code (RC1, RC2, . . . ).

6. A method according to claim 1, characterized in that the method further comprises the step of:
presenting to a user of the receiver (200) an amount to be paid in order to be presented with the broadcast signal (100) and presenting the broadcast signal (100) only if the user accept a payment of the amount.

7. A method according to claim 1, characterized in that the step of obtaining a decoding key (Dₖ) comprises:
selecting a secure cryptographic key and obtaining the decoding key (Dₖ) by performing a function on the secure cryptographic key and the obtained region code (RC1, RC2, . . . ).

8. A method according to claim 2, characterized in that the step of obtaining a pay-mode key (PMₖ) comprises:
selecting a secure cryptographic key and obtaining the pay-mode key (PMₖ) by performing a function on the secure cryptographic key and the obtained region code (RC1, RC2, . . . ).

9. A method of transmitting a broadcasting signal, the method comprising the steps of:
obtaining, in a broadcast device (300), a signal (S) to be transmitted to a number of receivers (200),
encoding the signal (S) with a number of orthogonal encoding keys (E_{k,1}, E_{k,2}, E_{k,3}, . . . ) and on the basis of one or more a region codes (RC1, RC2, . . . ) representing a region, thereby generating an encoded broadcast signal (100), and
transmitting the encoded broadcast signal (100) to a number of receivers (200).

10. A method according to claim 9, characterized in that the method further comprises the step of:
encoding the signal (S) or the encoded broadcast signal (100) with at least one pay-mode (PM) or pay-mode key (PMₖ) prior to transmitting the encoded broadcast signal (100).

11. A method according to claim 10, characterized in that
the encoding keys (E_{k,1}, E_{k,2}, E_{k,3}, . . . ) is dependent on the one or more region codes (RC1, RC2, . . . ) and the pay-mode key (PMₖ) is independent of the one or more region codes (RC1, RC2, . . . ), or
the pay-mode key (PMₖ) is dependent on the one or more region codes (RC1, RC2, . . . ) and the encoding keys (E_{k,1}, E_{k,2}, E_{k,3}, . . . ) are independent of the one or more region codes (RC1, RC2, . . . ), or
the encoding keys (E_{k,1}, E_{k,2}, E_{k,3}, . . . ) and the pay-mode key (PMₖ) are dependent on the obtained region codes (RC1, RC2, . . . ).

12. A broadcast device (300) comprising
an encoder (302) for receiving a signal (S) to be transmitted to a number of receivers (200) and for encoding the signal (S) with a number of orthogonal encoding keys (E_{k,1}, E_{k,2}, E_{k,3}, . . . ) and on the basis of one or more a region codes (RC1, RC2, . . . ), thereby generating an encoded broadcast signal (100), and
a transmitter circuit (301) for transmitting the encoded broadcast signal (100) to a number of receivers (200).

13. A receiver device (200) comprising
a receiver circuit (201) for receiving an encoded broadcast signal (100) from a broadcast device (300), where the encoded broadcast signal (100) have been encoded on the basis of at least one region code (RC1, RC2, . . . ) each representing a region,
location determination means (202, 206) for a obtaining a region code (RC1, RC2, . . . ) of a region that the receiver (200) is located in,
means (202) for obtaining a decoding key (Dₖ), and
a decoder (202) for decoding the broadcast signal (100) using the obtained decoding key (Dₖ) and on the basis of the obtained region code (RC1, RC2, . . . ).

14. A broadcasting system comprising at least one broadcast device (300) according to claim 12.

15. A computer readable medium having stored thereon instructions for causing one or more processing units to execute the method according to claim 1.
